(19) United States
(12) Patent Application Publication
(10) Pub. No.: US 2016/0286779 A1
(43) Pub. Date: Oct. 6, 2016

(54) AIRBORNE BIOTA MONITORING AND CONTROL SYSTEM

(71) Applicant: APPLIED INFORMATION MOVEMENT AND MANAGEMENT, INC, Starkville, MS (US)

(72) Inventor: David L. Guice, Brownsboro, AL (US)

(73) Assignee: APPLIED INFORMATION MOVEMENT AND MANAGEMENT, INC, Starkville, MS (US)

(21) Appl. No.: 15/084,433

(22) Filed: Mar. 29, 2016

Related U.S. Application Data
(63) Continuation-in-part of application No. 13/847,143, filed on Mar. 19, 2013, now Pat. No. 9,295,245.
Application No. 13/847,143 is a continuation of application No. 11/978,424, filed on Oct. 29, 2007, now Pat. No. 8,400,348.
Application No. 11/978,424 is a continuation-in-part of application No. 11/054,685, filed on Feb. 8, 2005, now Pat. No. 7,501,979.
Application No. 11/054,685 is a continuation-in-part of application No. 10/721,112, filed on Nov. 25, 2003, now Pat. No. 6,853,328.
Application No. 10/721,112 is a continuation-in-part of application No. 09/571,295, filed on May 14, 2000, now Pat. No. 6,653,971.
(60) Provisional application No. 60/134,081, filed on May 14, 1999.

(51) Int. Cl. A01M 3/00; G01S 17/66; G01S 13/66; A63F 9/02; A01M 5/00

(52) U.S. Cl. CPC A01M 3/007; A63F 9/0243; A01M 5/00; G01S 13/66; G01S 17/66; A01M 2200/01

(57) ABSTRACT

Apparatus and methods for an airborne biota monitoring and control system are disclosed. Radar and laser/optical sensors are used to detect insects, with detection zones being over water in some embodiments to reduce backscatter clutter. A pest control laser or small autonomous or radio controlled aircraft under automated or human control may be used to disable a targeted flying insect. Technologies include radars formed using semiconductor modules, such as are being developed for automotive radar and other industrial applications. Also disclosed are additional embodiments of the instant invention.

### CROSS REFERENCE TO RELATED APPLICATIONS

This application is a continuation-in-part of Applicant's U.S. patent application Ser. No. 13/847,143, filed Mar. 19, 2013, now U.S. Pat. No. 9,295,245, which issued Mar. 29, 2016, which is a continuation of Applicant's U.S. patent application Ser. No. 11/978,424, filed Oct. 29, 2007, now U.S. Pat. No. 8,400,348, which issued Mar. 19, 2013, which is a continuation-in-part of Applicant's U.S. patent application Ser. No. 11/054,685, filed Feb. 8, 2005, now U.S. Pat. No. 7,501,979, which issued Mar. 10, 2009, which is a continuation-in-part of Applicant's U.S. patent application Ser. No. 10/721,112, filed Nov. 25, 2003, now U.S. Pat. No. 6,853,328, which issued on Feb. 8, 2005, which was a continuation-in-part of Applicant's U.S. patent application Ser. No. 09/571,295, filed May 14, 2000, now U.S. Pat. No. 6,653,971 which issued Nov. 25, 2003, and which claimed the benefit of U.S. provisional patent application No. 60/134,081, filed May 14, 1999.

The instant application hereby incorporates Applicant's U.S. Pat. No. 6,653,971, entitled “Airborne Biota Monitoring and Control System,” herein by reference in its entirely, and also hereby incorporates Applicant's U.S. Pat. No. 6,853,328, also entitled “Airborne Biota Monitoring and Control System,” herein by reference in its entirety. The instant application also hereby incorporates Applicant's U.S. Pat. No. 7,501,979, also entitled “Airborne Biota Monitoring and Control System,” herein by reference in its entirety. The instant application also hereby incorporates Applicant's U.S. Pat. No. 8,400,348, also entitled “Airborne Monitoring and Control System,” herein by reference in its entirety. The instant application also hereby incorporates Applicant's U.S. Pat. No. 9,295,245, also entitled “Airborne Monitoring and Control System,” herein by reference in its entirety. The instant application also hereby incorporates Applicant's provisional U.S. patent application No. 60/134,081, also entitled “Airborne Monitoring and Control System,” herein by reference in its entirety.

### FIELD OF THE INVENTION

The systems, methods, and apparatus of the instant invention relate generally to monitoring and control of pest insects, and possibly other forms of airborne biota, and particularly to use of radars, ladars/lidars, and other sensors for detection and discrimination of pest insects from beneficial insects and other airborne biota, and use of lasers or other precision weapons including small radio-controlled aircraft for pest insect control. Some embodiments may include use of such technologies in conjunction with a video game or other entertainment application involving detection and control of pest insects. Systems, methods, and apparatus disclosed also provide for detection of pest insects or other pest activity within the protected volume using insect traps with miniaturized sensors and telemetry systems, and for detecting pest insect activity on or within crop plants or production animals using laser vibrometry and other laser and optical sensors.

### BACKGROUND OF THE INVENTION

Applicant's prior U.S. patents and patent applications described problems associated with pest insects and other airborne biota and described apparatus and methods for protecting crops and other assets from insects and other airborne biota. The instant application describes additional embodiments and methods of use for some of the component elements and inventions described in Applicant's prior U.S. patents and patent applications, some of which may now become preferred embodiments, and expands upon methods, apparatus, configuration, and technologies that may be used with benefit in some embodiments, including embodiments of the instant invention wherein some functions of some elements may be controlled by human operators who may be located adjacent to or remotely from a location of sensors, processors, and weapons. In some embodiments, human operators located remotely or in a vicinity of a protected area or pest insects, or other area where sensors and weapons are deployed, may be presented with displays based upon sensor observations and may operate controls so as to cause weapons to engage targets deemed to be harmful or potentially harmful to protected assets.

For some applications where regions that may be used as boundary zones may be limited in width or in another dimension through which insects may fly in entering (or in some cases, in exiting) a protected area or volume or in simply flying from one location to another, it may be desirable to have available additional measurement capabilities to support more rapid detection, tracking, and/or discrimination techniques so that pest insects and other pests may be more rapidly identified within a shorter time and/or shorter distance of flight. For example, discrimination techniques that rely primarily on characteristics associated with wing beat frequencies may require observation of a flying insect during several wing beat cycles to obtain adequate confidence in identification. Additionally, some insects, particularly butterflies, may coast for extended periods without flapping their wings. Consequently, additional measurements including reflected spectral characteristics and other characteristics such as polarization scattering matrices (which may provide information, for example, on target length to width ratios, or body orientation in flight) may be desirable to support more rapid identification of pest insects with a level of confidence adequate to support a decision to engage targets identified as pest insects, or targets requiring control for other reasons. The potential use of measurements of spectral characteristics to support target identification, or discrimination of pest insects from beneficial or neutral insects, was disclosed in Applicant's earlier patents and patent applications. A previous application expanded upon related but unobvious techniques that may also be applied to exploit dynamic characteristics of spectral information and other signatures that may be observed and/or measured.

The instant application also describes additional embodiments and/or features or technologies that may be incorporated with benefit in selected embodiments disclosed in Applicant's previous patents and patent applications, or in other embodiments that comprise obvious extensions of Applicant's instant and previous disclosures.

### BRIEF DESCRIPTION OF THE DRAWINGS

FIG. 1 is an isometric illustration (repeated from FIG. 1 of Applicant's U.S. Pat. No. 6,653,971 and described therein) of an embodiment of the invention that may be used to protect a crop field or other region.

FIGS. 2a and 2b are diagrammatic views (repeated from FIGS. 8a and 8b of Applicant's U.S. Pat. No. 6,653,971 and described therein) of weapon backstop material having a unique optical signature.

FIG. 3 is an elevation view (repeated and modified from FIG. 3a of Applicant's U.S. Pat. No. 8,400,348) of a representative sidewall boundary zone showing how four radar antenna may also be used to support detection and control of pest insects at essentially any location within a sidewall boundary zone.

FIG. 4 is a block diagram illustrating how a radar may be implemented using transmitter chips, receiver chips, a voltage control oscillator chip, and a microcontroller from one vendor.

FIG. 5 is an illustration showing how multiple segments of sidewall boundary zones may be combined to intercept insect pests.

### DETAILED DESCRIPTION OF THE DRAWINGS

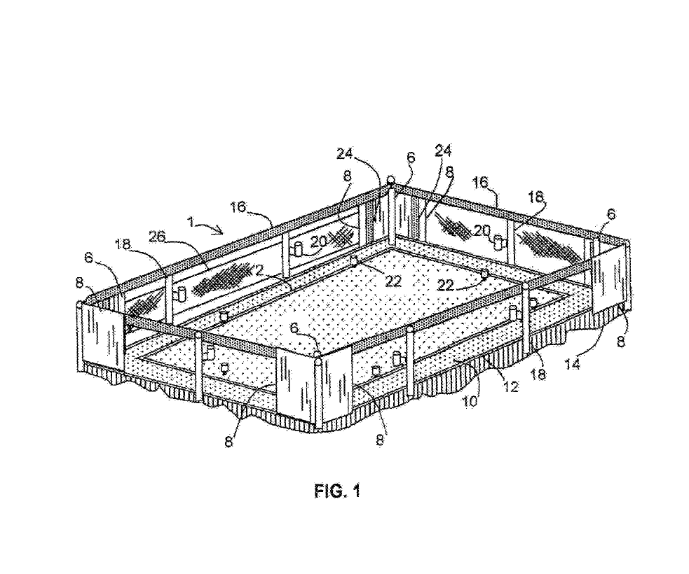

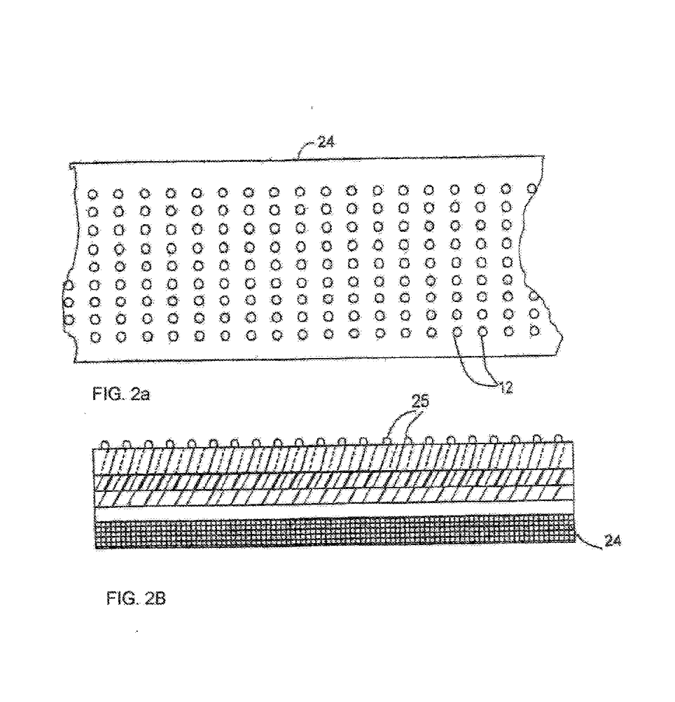

Airborne biota monitoring and control systems disclosed in the instant application and in Applicant's prior U.S. patents and patent applications include potential use of radar and optical sensor technologies, including ladar/lidar technologies) for detection and classification as pest or non-pest of insects entering (and/or, in some embodiments, leaving) a crop field or other volume or region which may include a crop or other asset to be protected from pest insects or other pests. Elements that may be included in some embodiments of the instant invention include sidewall and overhead laser kill plane backstops 16, 24, FIG. 1. These kill plane backstops may include retro-reflective elements 12, 25, FIGS. 2a, 2b, respectively, such as miniature corner reflectors or microbeads, to provide a unique optical signature and support a ready determination, via a low energy laser pulse, that the backstops are in place, and that non-targeted objects are not in the path of an impending kill laser pulse (as described in Applicant's U.S. Pat. No. 6,653,971, col. 11, lines 48 to 60, and col. 12, lines 17 to 33; and also in Applicant's U.S. Pat. No. 7,501,979, col. 3, lines 20 to 61, and FIGS. 2a and 2b therein).

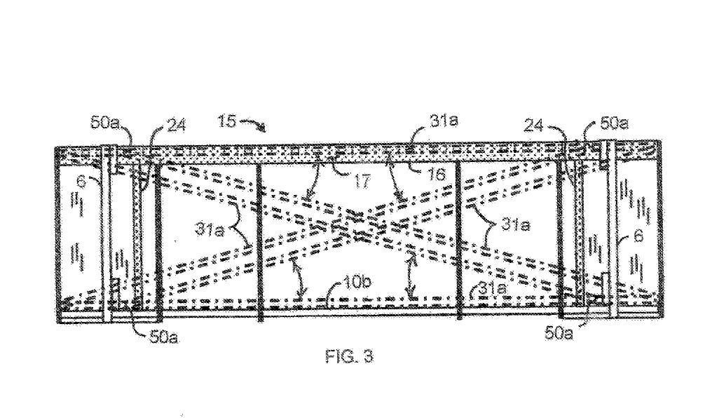

FIG. 3 in the instant application was used (as FIG. 3b) in Applicant's U.S. Pat. No. 8,400,348, and described in col. 5, line 61 through col. 6, line 22 therein, to illustrate how four laser/optical apertures may be used to provide optical detection and control of an airborne pest flying through essentially any portion of a sidewall boundary zone. It should be obvious that four radar apertures similarly placed near tops and bottoms of sensor weapon poles, which may be utility poles, street lamp poles, signage poles or the like, together with clutter control features disclosed in Applicant's prior patents, would also provide radar detection paths 31a, via steered or shaped antenna beams, which support detection and control of insect pests flying through essentially any portion of a sidewall boundary zone.

Although some embodiments of airborne biota monitoring and control systems for selected applications and markets may be implemented and perform adequately using only optical sensors without use of radar sensors, for many embodiments, the use of radar at one or more frequency ranges may be desirable since the longer wavelength of radars may provide information on an insect's overall body characteristics (such as length to width ratios, body orientation during flight, or total body mass estimated from measured radar cross-section) that may be useful discriminants but may not be readily observable using only sensors operating at optical (including infrared) wavelengths. The use of radar as described in disclosures of various embodiments of airborne biota monitoring and control systems will generally require detection of airborne objects (primarily insects in many embodiments) having very low radar cross section (RCS) values in a vicinity of objects which have much larger RCS values. Since it is difficult in current antenna design art to design radar antennas in a way which completely eliminates angle sidelobes, the use of radar beams to illuminate and detect desired “targets” having very low cross sections in a vicinity of materials and objects having very large radar scattering properties (e.g., uneven soil surface, weeds, grass, trees, crop plants and other plants, fences, utility lines and support structures, buildings, vehicles) is a particular problem to be addressed in many embodiments of airborne biota monitoring and control systems.

Although antennas may be designed so that gain in angle sidelobes in a particular direction or orientation is reduced by 30 dB or more relative to maximum gain in the main beam(s) of an antenna, if sidelobes illuminate materials at the same ranges as desired targets which have much greater backscattering properties (e.g., RCS values greater by 30 dB or more relative to desired insect targets), then backscattered energy received via angle sidelobes may substantially or completely obscure the energy backscattered from desired insect targets.

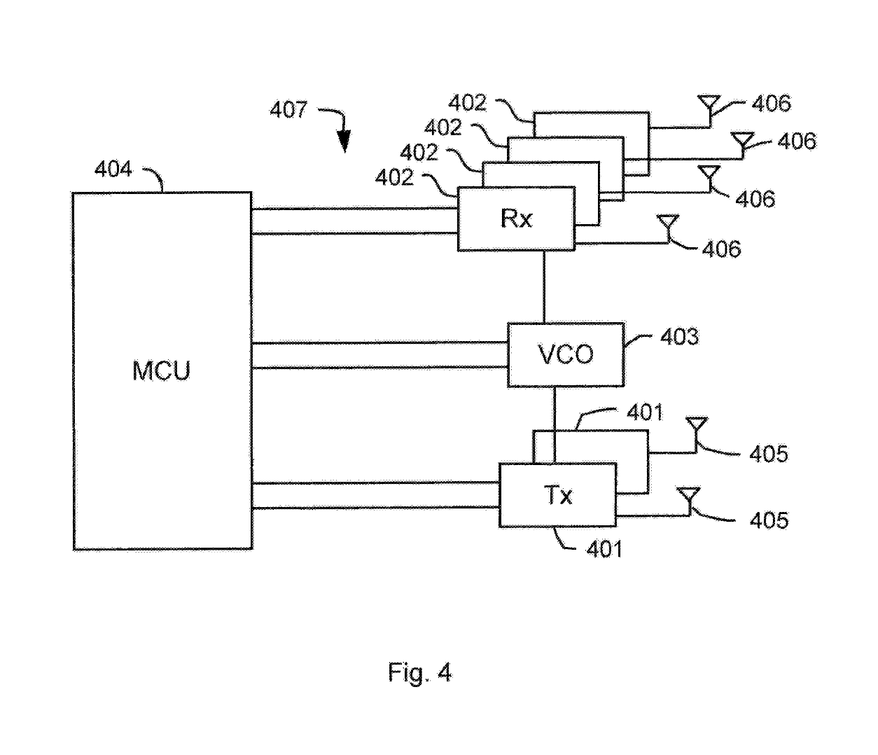

The problem of angle sidelobes is generally reduced at higher radar frequencies as compared with lower frequencies. Additionally, the signal-to-noise-plus-clutter ratio is generally improved by using shorter range bins (i.e., a higher resolution radar). Continuing improvements in radar technologies, and particularly the incorporation and integration of Silicon Germanium (SiGe:C) technologies with advanced CMOS and BiCMOS semiconductor technologies, now permits the implementation of significant radar capabilities, including RF transmit and receive stages, and substantial signal and data processing capabilities, into one or a few semiconductor chips. Chipsets are becoming available from several vendors to support implementation of automotive radar in allocated frequency bands, including bands around 24 GHz and 77 to 81 GHz. Some of these chipsets support high resolution capabilities using FMCW and other waveforms. Some chipsets support multiple transmit and/or receive channels, which could be used to support implementation of multiple switched antennas or electronically steered antennas, or the implementation of multiple transmit or receive polarizations. For example, one vendor, Freescale Semiconductors, now part of NXP Semiconductors, has shown how a 77 GHz radar may be implemented using their MR2001: Multi-channel 77 GHz Radar Transceiver Chipset. FIG. 4 is a representative block diagram illustrating how one or more transmitter chips 401 with an appropriate antennae 405 and one or more receiver chips 402 with appropriate antennae 406 may be combined with a voltage controlled oscillator 403 under control of a microcontroller 404 to provide a sophisticated radar 407 having significant processing capabilities.

These radar chipsets are going into mass production to support implementation of advanced driver assistance systems, as well as driverless automobiles. Radar in these and higher frequency ranges supported by the SiGe:C technologies are attractive for implementation of some embodiments of the instant invention. While transmitting in the frequency bands allocated for automotive radar may not be permitted by regulatory agencies, some vendors have indicated intent to provide a tuning capability outside the automotive bands for other applications, and those and other vendors would be able to make modifications and continued improvements to process technologies to provide semiconductor radar chips capable of operating in other available frequency bands ranging from around x-band up to over 200 GHz. Although chips being developed for automotive radar applications are generally limited in transmit power (for safety and mobile power applications), and would thus be limited to shorter ranges in embodiments of the instant invention, additional amplification modules could be incorporated into radar systems using similar chipsets modified to support alternate embodiments of the instant invention. Some embodiments of the instant invention may include hybrid radar systems employing more conventional transmitter technologies (e.g., travelling wave tubes) and receiver and processing capabilities employing the newer solid state receiver chipset technologies. The light weight and low power requirements of these and similar radar chipsets would also support implementation of radar on autonomously or remotely controlled aircraft such as disclosed in Applicant's prior patents.

Although there are multiple techniques involving antenna design, material selection, special geometries, and control of material and objects in a vicinity of radar beam propagation paths which can be employed within an embodiment of an airborne biota monitoring and control system to help reduce clutter return problems associated with illumination, by antenna sidelobes, of, and backscatter or forward scatter from, materials in a vicinity of an RF propagation path direction of a main beam(s) of the radar antenna, there are other techniques in the general areas of waveform design and signal processing which can be used separately, or in combination with, techniques cited herein in implementing such embodiments in order to reduce problems associated with detection and discrimination of airborne targets having small RCS values. One technique includes use of Doppler processing to distinguish clutter sources such as plant leaves which may have a steady or quasi-periodic motion component (e.g., perceived range rate) in a direct range direction (or in a propagation path direction in the case of intentionally or unintentionally scattered beams), such motion component being within the general range of values associated with desired targets (e.g., insects) as distinguished from undesired targets (e.g., leaves or blades of grass waving or vibrating in the wind).

Since vegetation in a vicinity of an antenna beam path may also have a more-or-less periodic motion component in a range direction (or propagation path direction as noted above), such vegetation being driven by wind or other air currents or water currents or rain, or by motion of animals or other sources, it may be desirable to implement processing techniques which exploit differences in periodicity of motion associated with flight of insects and other biota from quasi-cyclic motion of vegetation. This may require that a radar signal processor maintain running averages over various window lengths (in time) of amplitude variations of returns which may be associated with the motion of objects (i.e., scatterers) in various range cells and then apply conventional techniques to determine when there has been a change in a given range cell which may indicate presence of an insect or other target of interest within that particular range cell or within a collection of range cells. For example, by monitoring amplitude variations over a series of multiple pulses, and by performing Fourier transforms over various selected sampling intervals, it may be determined that motion of a vibrating leaf may be characterized by a particular frequency or set of frequencies. In continued monitoring and use of Fourier transforms, new frequency content may be detected from time to time within frequency ranges associated with wingbeat frequencies, respiration rates, or other frequency content which may be associated with presence of insects. For radars employing monopulse or other angle resolution techniques, detections in adjacent range and/or angle cells may be used to provide confidence in detection of a moving insect or other object versus false alarms (e.g., as may be induced by wind gusts).

In some cases, use of very stable circuits, and/or use of analog to digital converters with high sampling resolutions (e.g., 12 to 32 bit or greater sampling depths), may permit use of conventional signal processing techniques to detect presence of very small changes in amplitude or Doppler components of radar returns, which small changes may be associated with passage through a sampling volume (i.e., collection of range and angle cells) of insects or other biota. In order to distinguish small changes in amplitude (associated with RCS, Doppler, polarization ratios, or other properties) within a given range cell or group of range cells, it may be necessary for signal and data processing functions of a radar to maintain multiple “running averages” over multiple windowing periods selected to encompass useful ranges of variations in order to distinguish signal deviations resulting from normal quasi-periodic motion of vegetation from signal deviations associated with presence of insects and other targets of interest. Multiple parallel correlators or other micro-processors may be employed to permit “tracking” of various deviations from “normal” signal variations in order to permit detection of small changes which may indicate presence of insects and discriminate signal changes associated with insect targets from changes associated with other causes.

Multiple signals could be tracked to aid in distinguishing desired targets from clutter and to aid in discrimination among various types of desired targets (e.g., distinguishing moths from wasps and/or honeybees). This could include any or all of the various parameters which could be measured by various types of radars, including signals in multiple channels of such radars, and including such parameters as signal amplitude variations in sum and difference channels, variations associated with use of different polarizations on transmit and reception, correlation of Doppler with multipulse range changes, variations in Doppler shifts over multiple pulses, and dynamic (i.e., time varying) variations in amplitude, polarization, and other scattering properties associated with target motion and changes in target shapes.

Application of one or more of many conventional techniques known in arts of radar design, signal processing, and target discrimination, including techniques from a general area known as chaos theory, may be employed to support detection and discrimination of returns from desired targets from returns from clutter, and discrimination of one type of desired target from other types of desired targets.

Signal-to-noise-plus-clutter ratio may also be enhanced by using higher range resolution (i.e., shorter range cells). For many applications, range resolutions of approximately a foot or so may be desirable for reduction of clutter and to also help minimize an problems associated with multi-target interference, such as may occur when a radar is receiving energy from two or more desired targets at the same time (i.e., two or more targets within the same range cell or range resolution interval). Range resolutions of approximately a foot may be obtained by any of several known techniques, including use of short pulses, use of pulses encoded with pseudo-noise, also referred to as pseudo-random noise, as in PRN coded radars, with appropriate PRN decoding techniques included in the radar receiver, use of FMCW waveforms of sufficient bandwidth, or use of stepped frequency modulated pulses used in conjunction with a radar receiver capable of processing such pulses to obtain high range resolution (e.g., range cells of approximately one foot). High range resolution may also be obtained by using techniques and apparatus normally referred to in literature as ultra-wide band (UWB). Longer or shorter range cells may also be implemented as appropriate for various embodiments using these or other known techniques. Use of shorter range cells allows energy from a desired small target, such as an insect, to be detected while minimizing receipt of energy from undesired sources within the same range cell, such as clutter or other desired targets at longer or shorter ranges. Other technologies that may be used with benefit in some embodiments of airborne biota monitoring and control systems include technologies normally referred to as spread-spectrum, including such techniques as direct sequence code-division multiple access and fast or slow frequency hopping, and also include other technologies such as digital beam forming and adaptive antenna arrays that can adaptively steer antenna beams or nulls in selected directions.

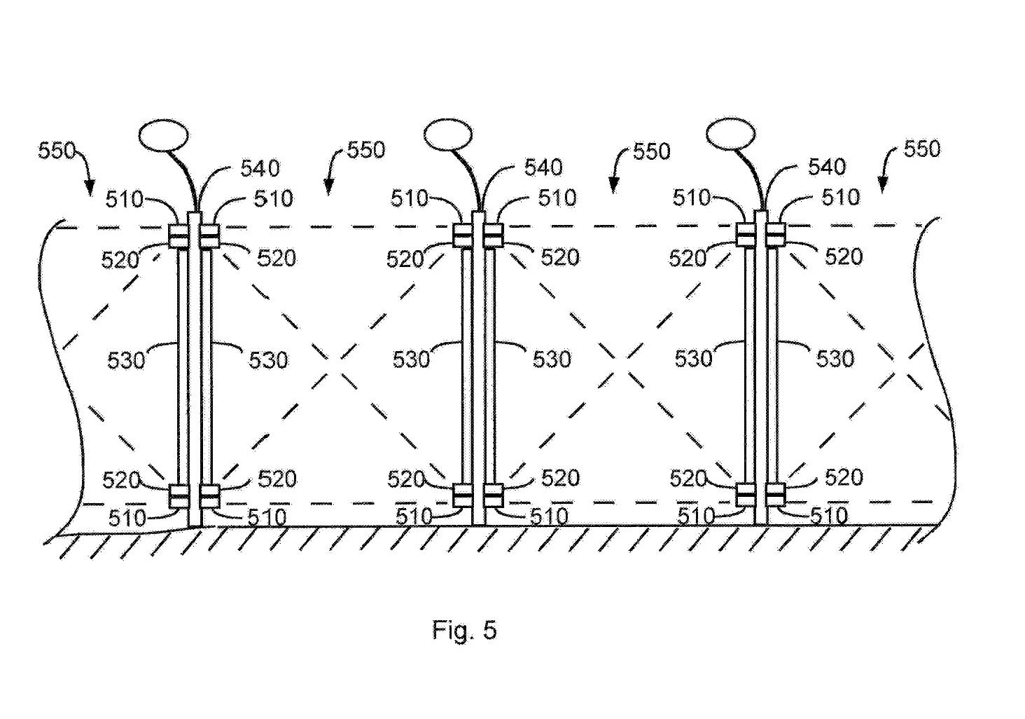

As was noted in Applicant's prior patents, multiple sidewall boundary zones may be used to intercept pest insects flying into a generally protected area (see for example, Applicant's U.S. Pat. No. 6,653,971, col. 9, lines 65 to 67, and col. 10, lines 1 to 9). Thus, some embodiments of the instant invention may employ components having optical and/or radar sensors 510, processors, and pest control lasers 520 mounted near tops and bottoms of narrow vertical strips of open-faced honeycomb 530 or other similar laser backstop materials and attached to either sides of a series of posts 540, for example street lamp posts or utility power poles, as illustrated in FIG. 5, so as to provide a series of boundary zone planes 550 that could prevent passage, or at least reduce populations, of pest insects, especially slow flying insects such as mosquitoes, passing from one area to another. Such a series of boundary zones is taught in Applicant's U.S. Pat. No. 6,653,971 at FIG. 6 and the paragraph bridging cols. 9-10, col. 10 lines 5-9 and col. 12 lines 34-39 wherein multiple narrow vertical backstops and sensor laser controls are installed in adjacent sections to form generally continuous barriers to intercept pest insects. Implementing such a series of pest-control zones could take advantage of power available at street lamp locations while preserving many of the safety features described in Applicant's prior patents. Such embodiments would be particularly useful in areas where neighborhoods are near marshes or the like, or other slow flowing bodies of water that breed mosquitoes, flies and other pest insects. Here, by way of example, where street light or utility poles are present between such marshes and neighborhoods, such as along a road, a series of adjacent, continuous boundary zones may be established between the poles to provide a barrier to insects attempting to cross from the marsh to the neighborhood.

Having thus described our invention and the manner of its use, it should be apparent from our disclosure to one skilled in the arts to which the subject application pertains that incidental changes may be made thereto that fairly fall within the scope of the following appended claims, wherein

We claim:

1. A method for killing or disabling insects comprising:
establishing one or more volumes that are observed for said insects,
when an insect of said insects is observed, tracking said insect until said insect's location is established,
killing or disabling said insect with an energy beam.
